(19) United States
(12) Patent Application Publication
(10) Pub. No.: US 2021/0304156 A1
(43) Pub. Date: Sep. 30, 2021

(54) SYSTEMS AND METHODS FOR CUSTOMER IDENTITY PROTECTION FROM SERVICE OR PRODUCT PROVIDERS

(71) Applicant: JPMORGAN CHASE BANK, N.A., New York, NY (US)

(72) Inventor: Tuan DAO, New York, NY (US)

(21) Appl. No.: 17/197,823

(22) Filed: Mar. 10, 2021

Related U.S. Application Data
(60) Provisional application No. 62/994,189, filed on Mar. 24, 2020.

(51) Int. Cl. G06Q 20/02; G06Q 30/04; G06Q 20/36; G06Q 20/10; G06Q 20/38

(52) U.S. Cl. CPC G06Q 20/02; G06Q 30/04; G06Q 20/38215; G06Q 20/102; G06Q 20/3672

(57) ABSTRACT

Systems and methods for systems and methods for customer identity protection from service or product providers are disclosed. In one embodiment, a method may include: receiving, by a trusted third-party and from a customer, a request for a verified vendor token for a vendor of a good or service; generating, by the trusted third-party, the verified vendor token comprising a unique identifier; mapping, by the trusted third-party, the unique identifier to a customer identifier; receiving, by the trusted third-party and from the vendor, the verified vendor token, verifying, by the trusted third-party, that the verified vendor token is valid; confirming, by the trusted third-party, a payment relationship with the vendor; receiving, by the trusted third-party and from the vendor, the verified vendor token and an invoice for the good or service; and issuing, by the trusted third-party, payment for the good or service to the vendor.

### RELATED APPLICATIONS

This application claims priority to, and the benefit of, U.S. Provisional Application Ser. No. 62/994,189 filed Mar. 24, 2020, the disclosure of which is hereby incorporated, by reference, in its entirety.

The disclosures of U.S. patent application Ser. No. 16/598,734, and U.S. Provisional Patent Application Ser. Nos. 62/856,491, 62/874,240, and 62/944,244 are hereby incorporated, by reference, in their entireties.

### BACKGROUND OF THE INVENTION

### 1. Field of the Invention

Embodiments generally relate to systems and methods for customer identity protection from service or product providers.

### 2. Description of the Related Art

Many service and product providers take advantages of the billing process to extract sensitive personal information from their customers. For example, it is common to collect customer address information, even though they provider may not be shipping to, or providing a service that requires knowledge of the customer's address. This information may be intentionally or unintentionally used for tracking, surveillance or monetization purposes, often without the consent or knowledge of the customers.

An example of such connection is the collection of address and social security numbers for wireless communication customers. Carriers require proof of user identity, and address, and a financial account in order to provide wireless service. Such information is stored by the carriers and associated with the SIM card. Thus, everywhere that the customer goes with the mobile phone, the SIM constantly communicates and authenticates with nearby cellular towers, thereby giving detailed locations for the customer. The aggregation and correlation of such data can reveal private activities, behaviors and interaction with other customers.

### SUMMARY OF THE INVENTION

Systems and methods for systems and methods for customer identity protection from service or product providers are disclosed. In one embodiment, a method for providing customer identity protection may include: (1) receiving, by a trusted third-party computer processor for a trusted third party and from a customer, a request for a verified vendor token for a vendor of a good or service; (2) generating, by the trusted third-party computer processor, the verified vendor token, the verified vendor token comprising a unique identifier; (3) mapping, by the trusted third-party computer processor, the unique identifier to a customer identifier maintained by the trusted third party; (4) receiving, by the trusted third-party computer processor and from the vendor, the verified vendor token, wherein the vendor received the verified vendor token from the customer; (5) verifying, by the trusted third-party computer processor, that the verified vendor token is valid; (6) confirming, by the trusted third-party computer processor, a payment relationship with the vendor; (7) receiving, by the trusted third-party computer processor and from the vendor, the verified vendor token and an invoice for the good or service; and (8) issuing, by the trusted third-party computer processor, payment for the good or service to the vendor.

In one embodiment, the method may further include: receiving, by the trusted third-party computer processor and from the vendor, one or more customer qualification rules; receiving, by the trusted third-party computer processor, customer information for the customer; and verifying, by the trusted third-party computer processor, that the customer is qualified by comparing the customer qualification rules to the customer information.

In one embodiment, the customer qualification rules comprise a minimum credit score, a minimum account balance, and/or a minimum age.

In one embodiment, the trusted third party may be a financial institution.

In one embodiment, the customer may be a customer of the financial institution.

In one embodiment, the method may further include: provisioning, by the trusted third-party computer processor, a vendor-specific payment token to the vendor, wherein the vendor-specific payment token may be mapped to a financial account for the customer, and the trusted third-party computer processor receives the vendor-specific payment token with the invoice; and the trusted third-party computer processor issues the payment for the good or service to the vendor from the financial account to the customer.

In one embodiment, the method may further include collecting, by the trusted third-party computer processor, payment for the invoice from the customer.

In one embodiment, the trusted third-party computer processor does not receive usage information regarding the goods or services from the vendor.

According to another embodiment, a system for providing customer identity protection may include: a customer electronic device; a vendor system for a vendor of a good or service comprising at least one computer processor; and a trusted third-party system for a trusted third party comprising at least one computer processor. The customer electronic device may be configured to: request a verified vendor token for the vendor from the trusted third-party system; generate the verified vendor token, the verified vendor token comprising a unique identifier; map the unique identifier to a customer identifier maintained by the trusted third-party system; communicate the verified vendor token to the customer device; receive the verified vendor token from the vendor system, wherein the vendor system received the verified vendor token from the customer; verify that the verified vendor token is valid; confirm a payment relationship with the vendor system; receive the verified vendor token and an invoice for the good or service from the vendor system; and issue payment for the good or service to the vendor system.

In one embodiment, the trusted third-party system may be further configured to: receive one or more customer qualification rules from the vendor system; receive customer information for the customer; and verify that the customer is qualified by comparing the customer qualification rules to the customer information.

In one embodiment, the customer qualification rules may include a minimum credit score, a minimum account balance, and/or a minimum age.

In one embodiment, the trusted third party may be a financial institution.

In one embodiment, the customer may be a customer of the financial institution.

In one embodiment, the trusted third-party computer processor may be further configured to: provision a vendor-specific payment token to the vendor, wherein the vendor-specific payment token is mapped to a financial account for the customer; receive the vendor-specific payment token with the invoice; and issue the payment for the good or service to the vendor from the financial account to the customer.

In one embodiment, the trusted third-party computer processor may be further configured to receive payment for the invoice from the customer.

In one embodiment, the trusted third-party computer processor may not receive usage information regarding the goods or services from the vendor.

According to another embodiment, a non-transitory computer readable medium is disclosed. The non-transitory computer readable medium may have stored thereon software instructions that, when executed by a processor, cause the processor to perform the following: receive a request for a verified vendor token for a vendor of a good or service from a customer, generate the verified vendor token, the verified vendor token comprising a unique identifier; map the unique identifier to a customer identifier maintained by a trusted third party; receive the verified vendor token from the vendor, wherein the vendor received the verified vendor token from the customer; verify that the verified vendor token is valid; confirm a payment relationship with the vendor; receive the verified vendor token and an invoice for the good or service from the vendor; and issue payment for the good or service to the vendor.

In one embodiment, the non-transitory computer readable medium may further comprise software instructions that, when executed by a processor, cause the processor to perform the following: receive one or more customer qualification rules from the vendor; receive customer information for the customer; and verify that the customer is qualified by comparing the customer qualification rules to the customer information.

In one embodiment, the customer qualification rules comprise a minimum credit score, a minimum account balance, and/or a minimum age.

In one embodiment, the non-transitory computer readable medium may further comprise software instructions that, when executed by a processor, cause the processor to perform the following: provision a vendor-specific payment token to the vendor, wherein the vendor-specific payment token is mapped to a financial account for the customer; receive the vendor-specific payment token with the invoice; and issue the payment for the good or service to the vendor from the financial account to the customer.

### BRIEF DESCRIPTION OF THE DRAWINGS

In order to facilitate a fuller understanding of the present invention, reference is now made to the attached drawings. The drawings should not be construed as limiting the present invention but are intended only to illustrate different aspects and embodiments.

FIG. 1 is a depicts a system for customer identity protection from service or product providers according to an embodiment; and

FIG. 2 depicts a method for customer identity protection from service or product providers according to an embodiment.

### DETAILED DESCRIPTION OF PREFERRED EMBODIMENTS

Embodiments are directed to systems and methods for customer identity protection from service or product providers.

In one embodiment, a transaction between a customer and a vendor may be bifurcated into two components: a payment component (e.g., a payment) and a personal component (e.g., name, address, social security number, date of birth, etc.). For example, certain vendors that provide goods or services to the customer may only need the payment component and not the personal component. Examples of such services include wireless phone services, internet-based services, etc. By having a trusted third party, such as a financial institution, provide the payment component for the customer, the customer may receive the goods or services without having to provide the vendor with the personal component.

In one embodiment, the trusted third party may not receive customer usage information for the goods or services. Thus, the vendor does not have the customer's personal data, and the trusted third party does not have the customer's usage activity. This provides benefits, such as protecting user privacy, a reduction in work required by the vendor to verify the user and collect payments, etc. If necessary, governmental agencies can still subpoena the vendor and/or the trusted third party for information.

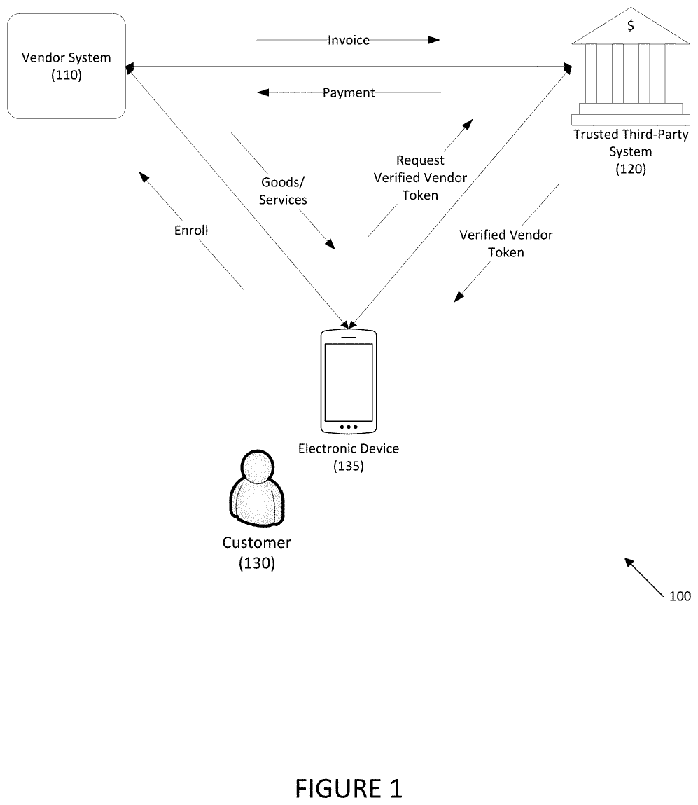

Referring to FIG. 1, a system for customer identity protection from service or product providers is provided according to one embodiment. System 100 may include vendor system 110, trusted third party system 120, and customer 130.

Customer may access vendor system 110 and/or trusted third party system 120 using electronic device 135, which may be any suitable electronic device, including smartphones, computers (e.g., tablet, notebook, desktop, workstation, terminal, etc.), kiosks, smart devices, Internet of Things (“IoT”) devices, etc.

Vendor system 110 may be a system for any suitable vendor that provides a good or service to customer 130. In one embodiment, the good or service that is provided may be one that does not require customer 130 to provide at least some of its personal identifying information, such as social security number, age, address, etc. Examples may include mobile phone services, streaming entertainment services, etc.

In one embodiment, the vendor may provide good/service to customer 130 that may require identity (e.g., this is a real person), age verification (e.g., is the person old enough to make this purchase), etc. For example, the vendor may provide an adult-oriented website. Trusted third party system 120 may provide any additional information while protecting the customer 130's privacy from the vendor.

In one embodiment, trusted third party system 120 may be a system for any suitable institution with which customer 130 may have an account, such as financial institutions (e.g., banks), financial technology (“FinTech”) service providers, etc. In another embodiment, trusted third party system 120 may be any suitable institution that may independently validate the customer's identity.

In one embodiment, vendor system 110, trusted third party system 120, and electronic device 135 may communicate using one or more suitable communications network.

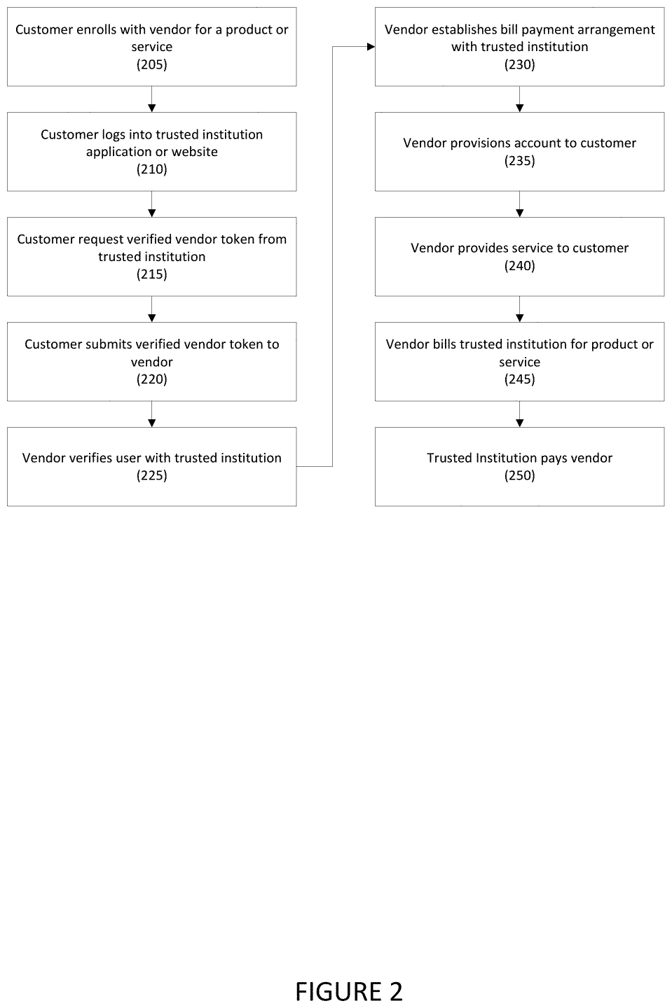

Referring to FIG. 2, a method for customer identity protection from service or product providers is provided according to one embodiment.

In step 205, a customer may enroll with a vendor to receive a good or service. In one embodiment, the good or service that is provided may be a good or service that does not require the customer to provide at least some of its personal identifying information, such as social security number, age, address, etc. Examples may include mobile phone service, streaming entertainment services, etc.

In one embodiment, the customer may provide the vendor with the minimum amount of information needed to provide the good or service, such as a phone number and/or an email address. Other information may be provided as is necessary and/or desired.

For example, if the vendor is a wireless phone provider, the customer may provide an alternate phone number. Other information may be provided as is necessary and/or desired.

In step 210, the customer may log in to an application or website for a trusted third party, such as a bank, a FinTech, etc. The customer may access the application or website using the customer's mobile electronic device.

In step 215, the customer, or the vendor on the customer's behalf, may request a verified vendor token from the trusted third party to provide to the vendor. In one embodiment, the verified vendor token may include a unique identifier that may identify the customer to the trusted third party.

The trusted third-party may map the unique identifier to a customer identifier that it may maintain in a database.

In step 220, the customer may provide or submit the verified vendor token to the vendor.

In step 225, the may provide the verified vendor token to the trusted third party. In one embodiment, the vendor and the trusted third party may configure business rules for verification, scoring, etc. the customer. For example, the vendor may require a certain credit score, a minimum account balance, a minimum age, etc., and the trusted third party may verify the customer based on these business rules.

In one embodiment, the trusted third party may provide the vendor with additional information about the customer while protecting the customer's privacy. For example, the trusted third party may verify that the customer is a real person (e.g., not a bot), is over a certain age (e.g., not a minor), lives in a certain geographical location (e.g., lives in the United States), etc. This information may be provided to the vendor as requested in order to meet the vendor's requirements for providing the good or service to the customer, while maintain the customer's privacy.

In step 230, the vendor may establish a billing arrangement with the trusted third party. For example, the trusted third party may arrange to have vendor bills submitted to the trusted third party with the verified vendor token for payment, may provision a vendor-specific token to the vendor, etc.

In one embodiment, the trusted third party may provision a vendor-specific payment token, account number, etc. to the vendor, and the vendor may use the vendor-specific payment token, account number to charge the customer for the goods or services. The vendor-specific payment token or account number may also be specific to the customer. In one embodiment, the vendor-specific payment token may be provisioned to a vendor electronic wallet or may be saved in a file on a vendor system.

In step 235, the vendor may provision an account for the customer, and in step 240, may provide the good or service to the customer.

In step 245, the vendor may bill the trusted third party for the good or service, and in step 250, the trusted third party may pay the vendor for the customer. For example, if the trusted third party is a financial institution, it may pay the vendor. If the trusted third party is not a financial institution, it may arrange for payment with a financial institution.

In step 250, the trusted third party may collect payment for the bill from the customer.

In one embodiment, under this arrangement, the amount of information that the vendor knows about the customer is limited to information that it needs to know in order to properly provide the good or service to the customer. The trusted third party does not know the good or service that the customer is receiving, or the use of that good or service by the customer.

The vendor may trust the trusted third party to provide payment on behalf of the customer, and may trust that the trusted third party has performed the appropriate checks (e.g., know your customer, anti-money laundering, etc.) on the customer.

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes disclosed herein.

The processing machine used to implement embodiments may utilize a suitable operating system. Thus, embodiments may include a processing machine running the iOS operating system, the OS X operating system, the Android operating system, the Microsoft Windows® operating systems, the Unix operating system, the Linux operating system, the Xenix operating system, the IBM AIX® operating system, the Hewlett-Packard UX® operating system, the Novell Netware® operating system, the Sun Microsystems Solaris® operating system, the OS/2® operating system, the BeOS® operating system, the Macintosh operating system, the Apache operating system, an OpenStep® operating system or another operating system or platform.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method. Rather, any number of different programming languages may be utilized as is necessary and/or desired.

Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while embodiments present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for providing customer identity protection, comprising:
receiving, by a trusted third-party computer processor for a trusted third party and from a customer, a request for a verified vendor token for a vendor of a good or service;
generating, by the trusted third-party computer processor, the verified vendor token, the verified vendor token comprising a unique identifier;
mapping, by the trusted third-party computer processor, the unique identifier to a customer identifier maintained by the trusted third party;
receiving, by the trusted third-party computer processor and from the vendor, the verified vendor token, wherein the vendor received the verified vendor token from the customer;
verifying, by the trusted third-party computer processor, that the verified vendor token is valid;
confirming, by the trusted third-party computer processor, a payment relationship with the vendor;
receiving, by the trusted third-party computer processor and from the vendor, the verified vendor token and an invoice for the good or service; and
issuing, by the trusted third-party computer processor, payment for the good or service to the vendor.

2. The method of claim 1, further comprising:
receiving, by the trusted third-party computer processor and from the vendor, one or more customer qualification rules;
receiving, by the trusted third-party computer processor, customer information for the customer; and
verifying, by the trusted third-party computer processor, that the customer is qualified by comparing the customer qualification rules to the customer information.

3. The method of claim 2, wherein the customer qualification rules comprise a minimum credit score, a minimum account balance, and/or a minimum age.

4. The method of claim 1, wherein the trusted third party is a financial institution.

5. The method of claim 4, wherein the customer is a customer of the financial institution.

6. The method of claim 1, further comprising:
provisioning, by the trusted third-party computer processor, a vendor-specific payment token to the vendor;
wherein the vendor-specific payment token is mapped to a financial account for the customer;
wherein the trusted third-party computer processor receives the vendor-specific payment token with the invoice; and
the trusted third-party computer processor issues the payment for the good or service to the vendor from the financial account to the customer.

7. The method of claim 1, further comprising:
collecting, by the trusted third-party computer processor, payment for the invoice from the customer.

8. The method of claim 1, wherein the trusted third-party computer processor does not receive usage information regarding the goods or services from the vendor.

9. A system for providing customer identity protection, comprising:
a customer electronic device;
a vendor system for a vendor of a good or service comprising at least one computer processor; and
a trusted third-party system for a trusted third party comprising at least one computer processor;
wherein:
the customer electronic device is configured to request a verified vendor token for the vendor from the trusted third-party system;
the trusted third-party system is configured to generate the verified vendor token, the verified vendor token comprising a unique identifier;
the trusted third-party system is configured to map the unique identifier to a customer identifier maintained by the trusted third-party system;
the trusted third-party system is configured to communicate the verified vendor token to the customer device;
the trusted third-party system is configured to receive the verified vendor token from the vendor system, wherein the vendor system received the verified vendor token from the customer;
the trusted third-party system is configured to verify that the verified vendor token is valid;
the trusted third-party system is configured to confirm a payment relationship with the vendor system;
the trusted third-party system is configured to receive the verified vendor token and an invoice for the good or service from the vendor system; and
the trusted third-party system is configured to issue payment for the good or service to the vendor system.

10. The system of claim 9, wherein:
the trusted third-party system is configured to receive one or more customer qualification rules from the vendor system;
the trusted third-party system is configured to receive customer information for the customer; and
the trusted third-party system is configured to verify that the customer is qualified by comparing the customer qualification rules to the customer information.

11. The system of claim 10, wherein the customer qualification rules comprise a minimum credit score, a minimum account balance, and/or a minimum age.

12. The system of claim 9, wherein the trusted third party is a financial institution.

13. The system of claim 12, wherein the customer is a customer of the financial institution.

14. The system of claim 10, wherein:
the trusted third-party computer processor is configured to provision a vendor-specific payment token to the vendor, wherein the vendor-specific payment token is mapped to a financial account for the customer;
the trusted third-party computer processor is configured to receive the vendor-specific payment token with the invoice; and
the trusted third-party computer processor is configured to issue the payment for the good or service to the vendor from the financial account to the customer.

15. The system of claim 10, wherein the trusted third-party computer processor is further configured to receive payment for the invoice from the customer.

16. The system of claim 10, wherein the trusted third-party computer processor does not receive usage information regarding the goods or services from the vendor.

17. A non-transitory computer readable medium having stored thereon software instructions that, when executed by a processor, cause the processor to perform the following:
receive a request for a verified vendor token for a vendor of a good or service from a customer,
generate the verified vendor token, the verified vendor token comprising a unique identifier;
map the unique identifier to a customer identifier maintained by a trusted third party;
receive the verified vendor token from the vendor, wherein the vendor received the verified vendor token from the customer;
verify that the verified vendor token is valid;
confirm a payment relationship with the vendor;
receive the verified vendor token and an invoice for the good or service from the vendor; and
issue payment for the good or service to the vendor.

18. The non-transitory computer readable medium of claim 17, further comprising software instructions that, when executed by a processor, cause the processor to perform the following:
receive one or more customer qualification rules from the vendor;
receive customer information for the customer; and
verify that the customer is qualified by comparing the customer qualification rules to the customer information.

19. The non-transitory computer readable medium of claim 18, wherein the customer qualification rules comprise a minimum credit score, a minimum account balance, and/or a minimum age.

20. The non-transitory computer readable medium of claim 17, further comprising software instructions that, when executed by a processor, cause the processor to perform the following:
provision a vendor-specific payment token to the vendor, wherein the vendor-specific payment token is mapped to a financial account for the customer;
receive the vendor-specific payment token with the invoice; and
issue the payment for the good or service to the vendor from the financial account to the customer.
